(19) United States
(12) Patent Application Publication
(10) Pub. No.: US 2026/0275648 A1
(43) Pub. Date: Sep. 17, 2026

(54) Embossed Tissue Products With Three-Dimensional Structure

(71) Applicant: Kimberly-Clark Worldwide, Inc., Neenah, WI (US)

(72) Inventors: Massimo Cagnone, Novara (IT); Giovanni Massarotti, Novara (IT); Guilia Silvestri, Novara (IT)

(21) Appl. No.: 19/550,862

(22) Filed: Feb. 26, 2026

Related U.S. Application Data
(63) Continuation of application No. PCT/US2024/044311, filed on Aug. 29, 2024.
(63) Continuation of application No. PCT/US2024/044317, filed on Aug. 29, 2024.
(60) Provisional application No. 63/535,826, filed on Aug. 31, 2023.
(60) Provisional application No. 63/535,847, filed on Aug. 31, 2023.

(51) Int. Cl. D21H 27/02; B31F 1/07; D21H 27/00; D21H 27/30

(52) U.S. Cl. CPC D21H 27/02; B31F 1/07; D21H 27/002; D21H 27/30; B31F 2201/0733; B31F 2201/0761

(57) ABSTRACT

A decorative tissue product is disclosed formed from multiple tissue plies. An embossing pattern is incorporated into at least one of the plies. The embossing pattern creates raised areas on an opposite side of the tissue ply. The embossing pattern can include embossed portions that form a continuous network and surround non-embossed portions. The non-embossed portions can be in the form of discrete shapes. In this manner, a pattern of discrete shapes can form elevated areas on a top surface of the tissue product, while the embossed portions form a background pattern. The embossed portions also form raised areas on the opposite side of the tissue sheet. An adhesive or water can be applied to these raised areas for adhering the top tissue ply to a bottom tissue ply.

### CROSS-REFERENCE TO RELATED APPLICATION

The present application is a continuation of International Patent Application No. PCT/US2024/044311 filed on Aug. 29, 2024, which is related and has right of priority to U.S. Provisional Patent Application No. 63/535,826 filed on Aug. 31, 2023, and is a continuation of International Patent Application No. PCT/US2024/044317 filed on Aug. 29, 2024, which is related and has right of priority to U.S. Provisional Patent Application No. 63/535,847 filed on Aug. 31, 2023, all of which are incorporated by reference in their entireties for all purposes.

### BACKGROUND

Consumer tissue products, such as facial tissue, bath tissue and other wiping products, are generally used to absorb liquids and fluids. Such paper products are predominantly formed of cellulosic papermaking fibers by manufacturing techniques designed specifically to produce several important properties. For example, the products should have good bulk, a soft feel, and should be highly absorbent. Further, the products should also have a pleasant aesthetic appearance and should be resilient against delamination in the environment in which they are used.

In the past, many attempts have been made to enhance certain physical properties of such products. For instance, to enhance the aesthetic appearance, decorative tissue products have been created by embossing a pattern into one or both sides of the tissue web during manufacturing. This standard mechanical embossing of shapes into the substrate can result in the deformation or breaking of fibers in an attempt to physically press the pattern into the web.

In addition to improving appearance, those skilled in the art have also attempted to use embossing to increase the thickness of the tissue product, particularly bath tissue. For instance, embossing patterns have been used in order to increase the thickness of multi-ply products in order to improve softness, tactile feel, and roll bulk.

In some applications, those skilled in the art have attempted to emboss patterns into high bulk and/or high loft webs, particularly through-air dried webs. Through-air dried webs are dried without compressing the webs creating sheets having relatively high bulk properties. These substrates, however, are typically not amenable to embossing processes. Embossed patterns created in the webs, for instance, are not well defined and have a tendency to fade as the tissue product ages.

Although patterned tissue products are well known and a wide variety of patterns have been employed, consumers continue to demand visually unique and appealing patterned tissue products. Accordingly, there remains a need for a tissue product having a pattern disposed on a surface of the product that provides consumers with a perception of softness and comfort while also being visually appealing. A need also exists for an embossed tissue product in which the embossing pattern improves at least one physical property, such as thickness or softness. A need also exists for an embossing process and embossing pattern than can successfully emboss patterns into high bulk and/or high loft webs without deteriorating their physical properties.

### SUMMARY

The present disclosure is generally directed to an embossed tissue product. The embossed tissue product includes at least two plies. An embossing pattern is formed into at least one of the plies. The embossing pattern can be a negative engraved embossing pattern that creates embossed portions that surround non-embossed, discrete shapes that form “pillow areas” on the opposite side of the sheet. In this manner, the resulting tissue product not only has aesthetic appeal but is also soft to the touch.

In one embodiment, the present disclosure is directed to a tissue product containing at least two tissue plies. A first tissue ply includes a first surface and a second and opposite surface. An embossing pattern is formed into the first tissue ply. The embossing pattern includes embossed portions that surround and form a pattern of discrete shapes on the first surface of the first tissue ply. The discrete shapes have a top surface lying in a first surface plane. The embossed portions form raised areas on the second surface of the first tissue ply. An upper surface of the raised areas lie in a second surface plane that is spaced from the first surface plane. The second surface of the first tissue ply is adhered to a first surface of a second tissue ply by applying an adhesive or water registered with the raised areas on the second surface of the first tissue ply. In accordance with the present disclosure, the embossed portions occupy greater than about 10% of the surface area of the second surface of the first ply.

In various embodiments, the embossed portions can occupy greater than about 15%, such as greater than about 20% of the surface area of the second surface of the first tissue ply and less than about 40%, such as less than about 38%, such as less than about 36% of the surface area of the second surface of the first tissue ply.

When an adhesive is used to bond the plies together, the adhesive applied to the raised areas of the embossed portions can cover greater than about 10%, such as greater than about 15%, such as greater than about 20% of the surface area of the second surface of the first tissue ply. The adhesive generally covers less than about 40%, such as less than about 38%, such as less than about 36% of the surface area of the second surface of the first tissue ply.

In one aspect, the embossed portions form enclosed shapes such that the embossed portions form a perimeter around the non-embossed discrete shapes. In one embodiment, the embossed portions can form a pattern of first shapes and second shapes corresponding to first pillow areas and second pillow areas on the first surface of the first ply. The embossing design can have an embossing depth of greater than about 0.4 mm, such as greater than about 0.6 mm, such as greater than about 0.8 mm, and less than about 2.5 mm, such as less than about 2 mm, such as less than about 1.5 mm. The embossing depth is measured from a top surface of a raised area of an embossed portion to a top surface of a discrete shape. In one aspect, the embossed portions can be continuous and intersecting. The second tissue ply can be a non-embossed sheet that is adhered to the first tissue ply. Alternatively, the second ply can be embossed with a pattern.

The first tissue ply and/or the second tissue ply can comprise a through-air dried web. For instance, the first ply and/or the second ply can comprise uncreped through-air dried webs. Each tissue ply can have a basis weight of from about 10 gsm to about 35 gsm, such as from about 14 gsm to about 28 gsm. The tissue product can have an overall basis weight of from about 28 gsm to about 80 gsm, such as from about 30 gsm to about 52 gsm.

In one aspect, the first tissue ply and the second tissue ply each contain at least about 50% by weight pulp fibers, such as softwood fibers, hardwood fibers, non-wood fibers, or combinations thereof. Each tissue ply can have a bulk of greater than about 5 cc/g, such as greater than about 7 cc/g, such as greater than about 9 cc/g. In one aspect, the embossed tissue product of the present disclosure can be spirally wound into a roll. In one particular embodiment, the tissue product can be a bath tissue. Alternatively, the tissue product can comprise a stack of interfolded individual sheets.

The first tissue ply and the second tissue ply can both comprise wet laid webs. Alternatively, the first tissue ply and the second tissue ply may comprise foam formed webs.

The present disclosure is also directed to a method for producing a tissue product and to a tissue product made by the method. The method includes passing a first tissue ply having a first surface and a second and opposite surface through a first nip between an engraved roll and an impression roll in order to emboss an embossing pattern into the first tissue ply. The engraved roll can comprise a pattern of raised embossing elements. The embossing pattern includes a pattern of embossed portions that correspond with the embossing elements and form raised areas on the second surface of the first tissue ply. The pattern of embossed portions form a pattern of non-embossed shapes. At least some of the shapes can form elevated areas on the first surface of the first tissue ply. An adhesive or water can be applied to the raised areas of the embossed portions. The first tissue ply and a second tissue ply can be passed through a second nip formed by a marrying roll to adhere the second tissue ply to the first tissue ply where the raised areas are located.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one embodiment of a tissue product made in accordance with the present disclosure;

FIG. 2 is a perspective view of one embodiment of a spirally wound tissue product made in accordance with the present disclosure;

FIG. 3 is a perspective view including an enlarged view of an embossing roller that may be used to form tissue products in accordance with the present disclosure;

FIG. 4 is a perspective view of another embodiment of an embossing roller including an enlarged view that may be used to form tissue products in accordance with the present disclosure;

FIG. 5 is a schematic illustration of an apparatus and process for embossing a tissue product in accordance with the present disclosure;

FIG. 6A is an enlarged view of the tissue product illustrated in FIG. 1;

FIG. 6B is a cross-sectional view along line 6B shown in FIG. 6A; and

FIG. 7 is one embodiment of a process for producing uncreped through-air dried tissue webs that may be embossed in accordance with the present disclosure.

Repeat use of reference characters in the present specification and drawings is intended to represent the same or analogous features or elements of the present invention.

### DEFINITIONS

As used herein, the term “Fibrous Structure” refers to a structure comprising a plurality of elongated particulate having a length to diameter ratio greater than about 10 such as, for example, papermaking fibers and more particularly pulp fibers, including both wood and non-wood pulp fibers, and synthetic staple fibers. A non-limiting example of a fibrous structure is a tissue web comprising pulp fibers.

As used herein, the term “Tissue Web” or “Tissue Ply” refers to a fibrous structure provided in sheet form and being suitable for forming a tissue product.

As used herein, the term “Tissue Product” refers to products made from tissue webs and includes, bath tissues, facial tissues, paper towels, industrial wipers, foodservice wipers, napkins, medical pads, and other similar products. Tissue products may comprise one, two, three or more plies.

As used herein, the term “Pattern” generally refers to the arrangement of one or more design elements. Within a given pattern the design elements may be the same or may be different, further the design elements may be the same relative size or may be different sizes. For example, in one embodiment, a single design element may be repeated in a pattern, but the size of the design element may be different from one design element to the next within the pattern.

As used herein, the term “Embossing Pattern or Design” generally refers to a decorative shape disposed across at least one dimension of a fibrous structure surface, the pattern may comprise a line element, discrete elements or other shapes. The embossing pattern comprises a portion of the fibrous structure lying out of plane with the surface plane of the fibrous structure. In general, the embossing pattern results from embossing the fibrous structure resulting in protrusions having a z-directional elevation on one side of the fibrous structure and raised areas on the opposite side of the fibrous structure.

As used herein, the term “Continuous Element” refers to an element, such as an embossing element or portion, disposed on a fibrous structure that extends without interruption throughout one dimension of the fibrous structure.

As used herein, the term “Discrete Element or Shape” refers to an element or shape, such as an embossed portion or non-embossed portion, disposed on a fibrous structure that does not extend continuously in any dimension of the fibrous structure.

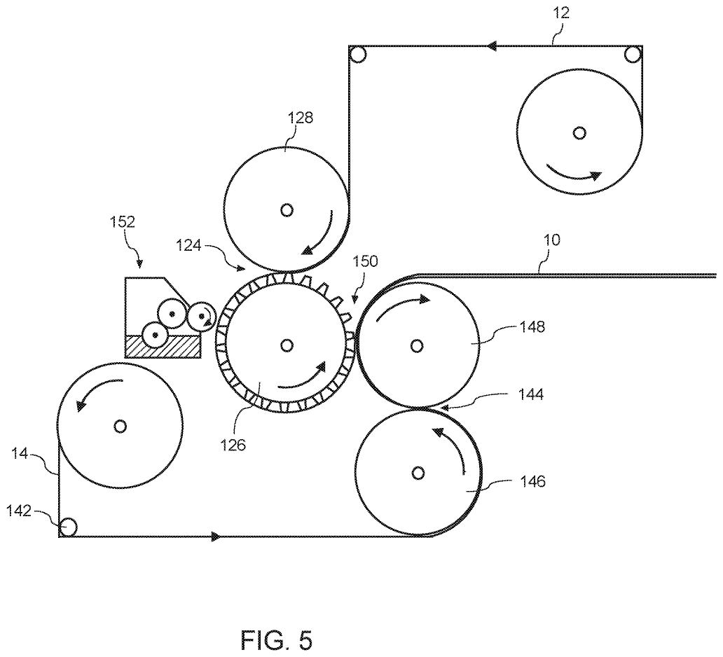

Tissue products produced according to the present invention may be analyzed by microscopy as described herein. Particularly, the three-dimensional surface topography and embossments may be analyzed by generating and analyzing product 3-D surface maps and cross-sections, such as those illustrated in FIGS. 5A-5C or WO 2022/075993, which is incorporated herein by reference. The images are taken using a VHX-1000 Digital Microscope manufactured by Keyence Corporation of Osaka, Japan. The microscope is equipped with VHX-5000 Communication Software Ver 1.5.1.1. The lens is an ultra-small, high performance zoom lens, VH-Z20R/Z20T.

The tissue product sample to be analyzed should be undamaged, flat, and include representative embossments. A normal sheet of bath tissue, approximately 4 inches×4 inches in size, works well. A three-dimensional image of the sample is obtained as follows:
1. Turn the digital microscope on and follow standard procedures for XY stage Initialization [Auto],
2. Turn the microscope magnification to ×100.
3. Place the tissue product sample on the stage with the first embossments facing up toward the lens.
4. If the fabric does not lie flat, place weights as needed along the perimeter to make fabric lie flat against the stage surface.
5. Use the focus adjustment to bring the fabric into sharp focus.
6. Select “Stitching” in the main menu. Select “3D stitching.”
7. Set the stitching method by selecting “Stitch around the current position.”
8. Select the Z set to set the upper and lower composition range. The upper limit should be set by going higher than the highest focal point that is clear. The lower limit should be set by going lower than the lowest focal point that is clear. After setting the upper and lower range, click OK.
9. Select “Start stitching” to begin accusation of the image.
10. In the 3D menu, select “Height/Color view” to identify dome-like features with the highest degree of topography.
11. In THE 3D menu, select “profile.”
12. With the “Profile line” tab selected obtain a cross-section of the tissue sample identified in Step 10, select “Line” and using the cursor to draw a line across the identified portion of the sample.

The line should bisect at least three adjacent first embossments. The peaks on the right and left side of the first embossments should be relatively planar (difference in height less than 10 percent). If the height difference between the peaks is more than 10 percent select another first embossment to measure.

To measure various embossment parameters, such as minimum and maximum heights and the distanced therebetween:
1. Select “Assist Tools.”
2. Select “Max” tool to identify the maximum point to the left of the first embossment, such as maximum point 83 to the left of the first embossment 80 of FIG. 5C of WO 2022/075993.
3. Select “Max” tool to identify the maximum point to the right of the first embossment, such as point 85 to the right of the first embossment 80 of FIG. 5C of WO 2022/075993.
4. Select “Min” tool to identify the minimum point in the first embossment, such as point 81 of the first embossment 80 of FIG. 5C of WO 2022/075993.

As used herein, “basis weight” is measured as follows. Prior to testing, all samples are conditioned under TAPPI conditions (23±1° C. and 50±2 percent relative humidity) for a minimum of 4 hours. Basis weight of a sample is measured by selecting twelve (12) products (also referred to as sheets) of the sample and making two (2) stacks of six (6) sheets. In the event the sample consists of perforated sheets of bath or towel tissue, the perforations must be aligned on the same side when stacking the usable units. A precision cutter is used to cut each stack into exactly 10.16×10.16 cm (4.0×4.0 inch) squares. The two stacks of cut squares are combined to make a basis weight pad of twelve (12) squares thick. The basis weight pad is then weighed on a top loading balance with a minimum resolution of 0.01 grams. The top loading balance must be protected from air drafts and other disturbances using a draft shield. Weights are recorded when the readings on the top loading balance become constant. The mass of the sample (grams) per unit area (square meters) is calculated and reported as the basis weight, having units of grams per square meter (gsm). While basis weight may be varied, tissue products prepared according to the present invention generally have a basis weight greater than about 10 gsm, such as from about 10 to about 80 gsm, such as from about 30 to about 60 gsm.

As used herein “caliper” is measured in accordance with TAPPI Test Method T 580 pm-12 “Thickness (caliper) of towel, tissue, napkin and facial products.” The micrometer used for carrying out caliper measurements is an Emveco 200-A Tissue Caliper Tester (Emveco, Inc., Newberg, OR). The micrometer has a load of 2 kilo-Pascals, a pressure foot area of 2,500 square millimeters, a pressure foot diameter of 56.42 millimeters, a dwell time of 3 seconds and a lowering rate of 0.8 millimeters per second. In one embodiment, caliper can be measured on 12 tissue webs or sheets stacked together.

As used herein the term “Sheet Bulk” refers to the quotient of the caliper (generally having units of μm) divided by the bone dry basis weight (generally having units of gsm). The resulting sheet bulk is expressed in cubic centimeters per gram (cc/g). While sheet bulk may vary depending on any one of a number of factors, tissue products prepared according to the present invention may have a sheet bulk greater than about 5 cc/g, such as greater than about 10 cc/g and still more preferably greater than about 12 cc/g, such as from about 5.0 to about 20.0 cc/g.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a tissue product including an embossing pattern that provides a three-dimensional, aesthetically pleasing effect. The embossing pattern can be incorporated into any suitable tissue product, such as a bath tissue. Once applied to a tissue product, the embossing design can increase the thickness of the product, can have a softer feel, and/or can have the appearance of a premium high quality product.

Improved properties and characteristics of tissue products are created in accordance with the present disclosure using an embossing pattern that includes a network of embossed areas that surround and form discrete shapes in a tissue ply. The embossed areas, for instance, can form a continuous background pattern that surrounds each of the discrete shapes. The discrete shapes represent non-embossed areas on the tissue ply. In this manner, the non-embossed shapes, in one aspect, can form elevated areas on one surface of the tissue ply while the embossed areas can form raised areas on the opposite surface of the tissue ply. An adhesive or water (to promote hydrogen bonding) can then be selectively applied to the embossed areas for attaching the embossed first tissue ply to a second tissue ply such that the non-embossed pattern of shapes forms an exterior surface of the resulting product. Once attached to an adjacent tissue ply, the resulting tissue product has a unique pattern that provides the product not only with a distinctive look that is appealing to consumers, but also with, in one aspect, an enhanced thickness and tactile feel that are also highly desirable.

The embossed areas formed into the tissue ply as described above occupy a significant amount of surface area in order to create the pattern of discrete shapes in the non-embossed areas. For example, the embossed areas can occupy greater than about 10%, such as greater than about 15% of the surface area of the tissue ply. Even though the embossed areas occupy a significant area on the surface of the tissue ply, it was unexpectedly discovered that the resulting pattern still provides a product with overall softness without an excessive amount of stiffness. For instance, the discrete shapes formed by the embossing pattern can produce very defined three-dimensional domes on the surface of the product which can create a “pillow-like” effect.

The embossing pattern of the present disclosure is particularly well suited for embossing high bulk tissue sheets that were not amenable to many conventional embossing processes used in the past. High bulk sheets, such as through-air dried sheets, for instance, are somewhat resistant to embossing patterns. When attempts have been made to emboss these tissue webs in the past, the embossing patterns frequently faded and did not create a visual effect and/or increase any softness properties of the web. Consequently, through-air dried webs are typically dried on a highly complicated and three-dimensional forming fabric for creating patterns in the webs. These high topography fabrics are not only expensive to manufacture and produce but also increase the energy requirements in producing the tissue products. Further, the high topography fabrics need to be removed and replaced when switching from one product to another leading to machine downtime and increased labor requirements. The embossing pattern and process of the present disclosure, however, is well suited to forming a visually appealing pattern and look into a high bulk web and can also increase the caliper and/or softness of the tissue product, while avoiding all of the disadvantages of using a high topography fabric during through-air drying.

As will be described in greater detail below, in one aspect, in order to produce tissue products made in accordance with the present disclosure, a tissue ply is embossed by an engraved roll that applies an embossing pattern to the tissue ply. In one aspect, the embossing roll is a negative engraved roll that embosses a significant portion of a tissue ply being processed. A negative engraved roll includes a pattern of shapes that are recessed on the roll or form depressions or cavities and are surrounded by raised embossing elements. In this manner, when a tissue ply is embossed, a background pattern of embossed areas are created that surround a pattern of non-embossed shapes that correspond to the depressions or cavities on the roll.

The engraved roll can be used in an embossing process that includes a lamination step that adhesively laminates the embossed tissue ply to an adjacent tissue ply using an adhesive or water. The adhesive or water can be applied selectively and intermittently for adhering the two plies together. For example, in one embodiment, the adhesive or water can be coordinated with raised areas on the embossed ply that is then used to adhere the two plies together in a manner that produces internal free space.

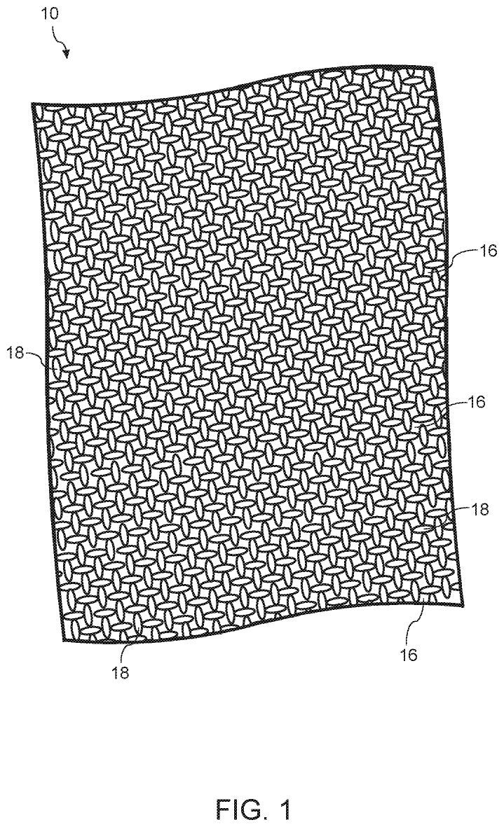

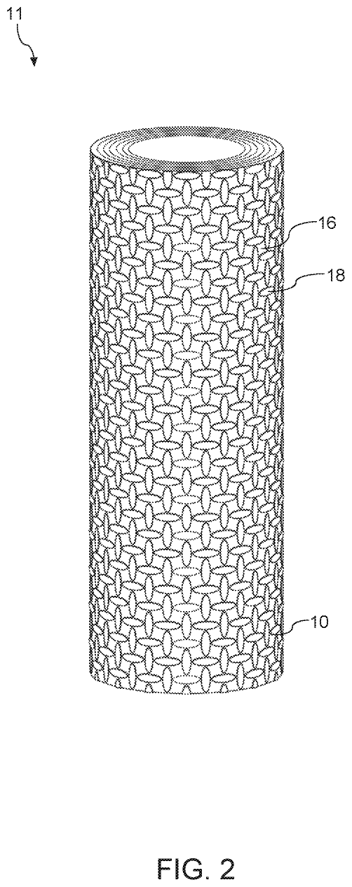

Referring to FIGS. 1, 2, 6A and 6B, one embodiment of a tissue product made in accordance with the present disclosure is shown. The embodiment illustrated in FIGS. 1, 2, 6A and 6B is merely exemplary and the teachings of the present disclosure can be applied to many different patterns for creating all different types of looks. FIG. 1 is a plan view of a multi-ply tissue product 10 made in accordance with the present disclosure. The multi-ply tissue product 10 can be spirally wound to form a roll 11 as shown in FIG. 2. Alternatively, the multi-ply tissue product 10 as shown in FIG. 1 can be cut into individual sheets. The individual sheets, for instance, can be interfolded and provided to consumers in a stack. The multi-ply tissue product 10 can be constructed in order to form various different tissue products. Such tissue products can include a spirally wound product 11 as shown in FIG. 2 and may comprise a bath tissue, a paper towel, or an industrial wiper. Alternatively, the multi-ply tissue product 10 can be packaged in individual sheets and sold as a facial tissue, cosmetic wipe, or as a consumer or industrial wiper.

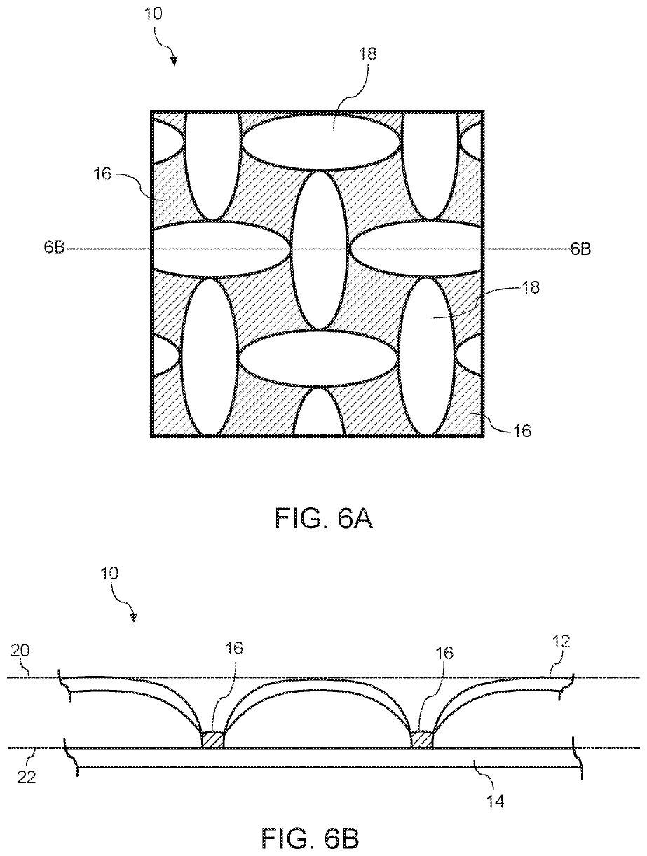

FIG. 6A illustrates an enlarged portion of the multi-ply tissue product 10 as shown in FIG. 1. FIG. 6B, on the other hand, is a cross-sectional view of the multi-ply tissue product 10 taken along line 6B in FIG. 6A. As shown in FIG. 6B, the tissue product 10 includes a first or top tissue ply 12 laminated to a second tissue ply 14. The first tissue ply 12 is embossed in accordance with the present disclosure. In the embodiment illustrated in FIG. 6B, the second tissue ply 14 is a non-embossed sheet. In other embodiments, however, the second tissue ply 14 can be embossed. For instance, in one embodiment, the second tissue ply 14 can be embossed with the same pattern as the first tissue ply 12 (and laminated to the first tissue ply in a reverse orientation).

As shown in FIGS. 1, 2, 6A and 6B, the first tissue ply 12 includes an embossing pattern made in accordance with the present disclosure. The embossing pattern includes embossed portions 16 that surround and define non-embossed discrete shapes 18. The embossed portion 16, for instance, can comprise a background pattern that forms the discrete shapes 18. In one aspect, the background pattern of the embossed portions 16 can completely surround and enclose the discrete shapes 18, forming a perimeter around each shape. In one aspect, the embossed portions 16 form a continuous and interconnected pattern.

Referring to FIG. 6B, a cross-sectional view of the embossing pattern and of the multi-ply tissue product 10 is illustrated. As shown particularly in FIG. 6B, the embossed portions 16 form raised areas on the back side of the first tissue ply 12. The non-embossed discrete shapes 18, on the other hand, can form raised areas on the first side or top surface of the first tissue ply 12. In this manner, the thickness and bulk of the first tissue ply 12 can be greatly enhanced.

As shown in FIG. 6B, the first tissue ply 12 is laminated to the second tissue ply 14 to form the multi-ply tissue product 10. For instance, the first tissue ply 12 can be adhered to the second tissue ply 14 by applying an adhesive or water (to promote hydrogen bonding) in a pattern that is registered with the raised areas formed by the embossed portions 16. In this manner, the first tissue ply 12 is adhered to the second tissue ply 14 where the embossed portions 16 contact the second tissue ply 14 as shown particularly in FIG. 6B. The embossing pattern can produce a three-dimensional configuration in which the discrete shapes 18 have a top surface lying in a first surface plane 20. The raised areas of the embossed portions 16, on the other hand, lie in a second surface plane 22 that is spaced from the first surface plane 20. The first surface plane 20 can be parallel with the second surface plane 22. The distance between the first surface plane 20 and the second surface plane 22 represents the depth of the embossing pattern formed into the first tissue ply 12.

The distance between the first surface plane 20 and the second surface plane 22 can depend upon various factors, including the type of tissue product being formed and the basis weight of the webs. In one aspect, the distance between the first surface plane 20 and the second surface plane 22 can be greater than about 0.2 mm, such as greater than about 0.4 mm, such as greater than about 0.6 mm, such as greater than about 0.8 mm, such as greater than about 1 mm, such as greater than about 1.2, such as greater than about 1.4 mm, such as greater than about 1.6 mm, and less than about 4 mm, such as less than about 3.5 mm, such as less than about 3 mm, such as less than about 2.5 mm, such as less than about 2 mm, such as less than about 1.8 mm, such as less than about 1.5 mm.

As shown in FIG. 6B, the embossing pattern including the embossed portions 16 and the non-embossed discrete shapes 18 produces a tissue product 10 that can have open interior space that allows for air flow and enhanced thickness. In this manner, the discrete shapes 18 can form “pillow areas” on the surface of the tissue product 10. The embossing pattern can thus not only produce a tissue product 10 with enhanced thickness and bulk, but can also provide a pleasing soft feel.

It was unexpectedly discovered that the above benefits can be obtained while embossing a significant portion of the surface area of the first tissue ply 12. For example, the embossed portions can occupy greater than about 10% of the surface area of the first tissue ply 12. More particularly, the raised areas of the embossed portions can occupy greater than about 15%, such as greater than about 18%, such as greater than about 20%, such as greater than about 22%, such as greater than about 25%, such as greater than about 28%, such as greater than about 30% of the surface area of the first tissue ply 12. In one aspect, the raised areas of the embossed portions occupy less than about 40%, such as less than about 38%, such as less than about 36%, such as less than about 34%, such as less than about 32%, such as less than about 30%, such as less than about 28%, such as less than about 26%, such as less than about 24% of the surface area of the first tissue ply 12.

As described above, an adhesive or water is applied to the raised areas of the embossed portions for laminating the first tissue ply to the second tissue ply. Thus, the adhesive or water applied to the second surface of the first tissue ply 12 can cover greater than about 10%, such as greater than about 15%, such as greater than about 20%, and less than about 40%, such as less than about 38%, such as less than about 36% of the surface area of the second surface of the first tissue ply 12.

In general, any suitable tissue web can be embossed in accordance with the present disclosure and incorporated into the tissue product 10. The embossing process of the present disclosure, however, is particularly well suited to embossing high loft and resilient tissue webs, such as through-air dried webs, particularly uncreped through-air dried webs. As described above, embossing patterns made according to the present disclosure generally emboss significant portions of the tissue web in a continuous manner. The amount of embossing that occurs may increase the stiffness of certain webs. It was discovered, however, that through-air dried webs, particularly uncreped through-air dried webs, can be embossed in accordance with the present disclosure for enhancing one or more properties including thickness and softness without negatively impacting stiffness.

Tissue products and the tissue plies incorporated into the product can generally have a bulk density of greater than about 3 cc/g, such as greater than about 5 cc/g, such as greater than about 6 cc/g, such as greater than about 7 cc/g, such as greater than about 8 cc/g, such as greater than about 9 cc/g, such as greater than about 10 cc/g, and generally less than about 20 cc/g.

Fibers suitable for making tissue webs comprise any natural or synthetic cellulosic fibers including, but not limited to nonwoody fibers, such as cotton, abaca, kenaf, sabai grass, flax, esparto grass, straw, jute hemp, bagasse, milkweed floss fibers, and pineapple leaf fibers; and woody or pulp fibers such as those obtained from deciduous and coniferous trees, including softwood fibers, such as northern and southern softwood kraft fibers; hardwood fibers, such as eucalyptus, maple, birch, and aspen. Pulp fibers can be prepared in high-yield or low-yield forms and can be pulped in any known method, including kraft, sulfite, high-yield pulping methods and other known pulping methods. Fibers prepared from organosolv pulping methods can also be used, including the fibers and methods disclosed in U.S. Pat. No. 4,793,898, issued Dec. 27, 1988 to Laamanen et al.; U.S. Pat. No. 4,594,130, issued Jun. 10, 1986 to Chang et al.; and U.S. Pat. No. 3,585,104. Useful fibers can also be produced by anthraquinone pulping, exemplified by U.S. Pat. No. 5,595,628 issued Jan. 21, 1997, to Gordon et al.

A portion of the fibers, such as up to 50% or less by dry weight, or from about 5% to about 30% by dry weight, can be synthetic fibers such as rayon, polyolefin fibers, polyester fibers, bicomponent sheath-core fibers, multi-component binder fibers, and the like. Regenerated cellulose fiber types include rayon in all its varieties and other fibers derived from viscose or chemically-modified cellulose.

Chemically treated natural cellulosic fibers can be used such as mercerized pulps, chemically stiffened or crosslinked fibers, or sulfonated fibers. For good mechanical properties in using papermaking fibers, it can be desirable that the fibers be relatively undamaged and largely unrefined or only lightly refined. While recycled fibers can be used, virgin fibers are generally useful for their mechanical properties and lack of contaminants. Mercerized fibers, regenerated cellulosic fibers, cellulose produced by microbes, rayon, and other cellulosic material or cellulosic derivatives can be used. Suitable papermaking fibers can also include recycled fibers, virgin fibers, or mixes thereof. In certain embodiments capable of high bulk and good compressive properties, the fibers can have a Canadian Standard Freeness of at least 200, more specifically at least 300, more specifically still at least 400, and most specifically at least 500.

Other papermaking fibers that can be used in the present disclosure include paper broke or recycled fibers and high yield fibers. High yield pulp fibers are those papermaking fibers produced by pulping processes providing a yield of about 65% or greater, more specifically about 75% or greater, and still more specifically about 75% to about 95%. Yield is the resulting amount of processed fibers expressed as a percentage of the initial wood mass. Such pulping processes include bleached chemithermomechanical pulp (BCTMP), chemithermomechanical pulp (CTMP), pressure/pressure thermomechanical pulp (PTMP), thermomechanical pulp (TMP), thermomechanical chemical pulp (TMCP), high yield sulfite pulps, and high yield Kraft pulps, all of which leave the resulting fibers with high levels of lignin. High yield fibers are well known for their stiffness in both dry and wet states relative to typical chemically pulped fibers.

The tissue web may be formed from a fiber furnish containing pulp fibers in an amount of at least about 50% by weight, such as at least about 60% by weight, such as at least about 70% by weight, such as at least about 80% by weight, such as at least about 90% by weight, such as 100% by weight.

The tissue web can also be formed without a substantial amount of inner fiber-to-fiber bond strength. In this regard, the fiber furnish used to form the base web can be treated with a chemical debonding agent. The debonding agent can be added to the fiber slurry during the pulping process or can be added directly to the headbox. Suitable debonding agents that may be used in the present disclosure include cationic debonding agents such as fatty dialkyl quaternary amine salts, mono fatty alkyl tertiary amine salts, primary amine salts, imidazoline quaternary salts, silicone quaternary salt and unsaturated fatty alkyl amine salts. Other suitable debonding agents are disclosed in U.S. Pat. No. 5,529,665 to Kaun which is incorporated herein by reference. In particular, Kaun discloses the use of cationic silicone compositions as debonding agents.

In one embodiment, the debonding agent used in the process of the present disclosure is an organic quaternary ammonium chloride and, particularly, a silicone-based amine salt of a quaternary ammonium chloride. For example, the debonding agent can be PROSOFT® TQ1003, marketed by the Hercules Corporation. The debonding agent can be added to the fiber slurry in an amount of from about 1 kg per metric tonne to about 10 kg per metric tonne of fibers present within the slurry.

In an alternative embodiment, the debonding agent can be an imidazoline-based agent. The imidazoline-based debonding agent can be obtained, for instance, from the Witco Corporation. The imidazoline-based debonding agent can be added in an amount of between 2.0 to about 15 kg per metric tonne.

Optional chemical additives may also be added to the aqueous papermaking furnish or to the formed embryonic web to impart additional benefits to the product. The following materials are included as examples of additional chemicals that may be applied to the web. The chemicals are included as examples and are not intended to limit the scope of the invention. Such chemicals may be added at any point in the papermaking process.

Additional types of chemicals that may be added to the paper web include, but is not limited to, absorbency aids usually in the form of cationic, anionic, or non-ionic surfactants, humectants and plasticizers such as low molecular weight polyethylene glycols and polyhydroxy compounds such as glycerin and propylene glycol. Materials that supply skin health benefits such as mineral oil, aloe extract, vitamin e, silicone, lotions in general and the like may also be incorporated into the finished products. Dry strength and wet strength agents can also be incorporated into the tissue plies.

In general, the products of the present invention can be used in conjunction with any known materials and chemicals that are not antagonistic to its intended use. Examples of such materials include but are not limited to odor control agents, such as odor absorbents, activated carbon fibers and particles, baby powder, baking soda, chelating agents, zeolites, perfumes or other odor-masking agents, cyclodextrin compounds, oxidizers, and the like. Superabsorbent particles may also be employed.

Tissue webs that may be treated in accordance with the present disclosure may include a single homogenous layer of fibers or may include a stratified or layered construction. For instance, each tissue web ply may include two or three layers of fibers.

The basis weight of tissue webs made in accordance with the present disclosure can vary depending upon the final product. For example, the process may be used to produce bath tissues, facial tissues, paper towels, industrial wipers, and the like. In general, the basis weight of the tissue products may vary from about 10 gsm to about 110 gsm, such as from about 20 gsm to about 90 gsm. For bath tissue and facial tissues, for instance, the basis weight may range from about 10 gsm to about 40 gsm. For paper towels, on the other hand, the basis weight may range from about 25 gsm to about 80 gsm.

In one embodiment, the tissue product can have a basis weight of from about 28 gsm to about 80 gsm, such as from about 30 gsm to about 52 gsm.

When constructing multi-ply tissue products in accordance with the present disclosure, each tissue ply can have the same basis weight or can have a different basis weight. Each tissue ply can generally have a basis weight of from about 10 gsm to about 60 gsm, including all increments of 1 gsm therebetween. For example, each tissue ply can have a basis weight of greater than about 10 gsm, such as greater than about 12 gsm, such as greater than about 15 gsm, such as greater than about 18 gsm, such as greater than about 20 gsm, such as greater than about 22 gsm, such as greater than about 25 gsm. Each tissue ply can have a basis weight of generally less than about 45 gsm, such as less than about 40 gsm, such as less than about 35 gsm, such as less than about 33 gsm, such as less than about 30 gsm, such as less than about 28 gsm, such as less than about 25 gsm.

In general, any process capable of forming a tissue web can be utilized in order to form each of the tissue plies used to produce the tissue product of the present disclosure. The process of making the tissue web, for instance, can utilize creping, wet creping, double creping, web pressing, air pressing, through-air drying, creped through-air drying, uncreped through-air drying, hydroentangling, and the like. The tissue webs made according to the present disclosure can be formed through a wetlaid process or through a foam forming process. When producing bath or facial tissues, the use of airlaid webs may be avoided in one embodiment. Alternatively, airlaid webs can be embossed in accordance with the present disclosure.

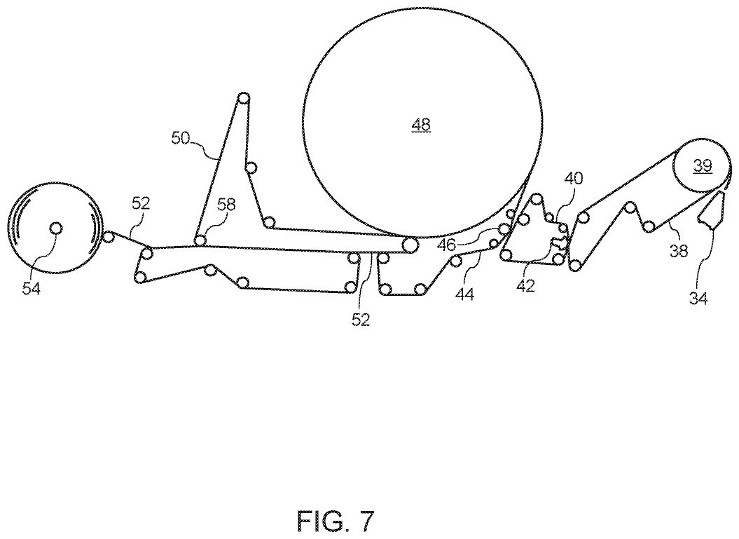

As described above, the embossing process of the present disclosure is particularly well suited to embossing through-air dried webs, such as uncreped through-air dried webs. Referring to FIG. 7, for instance, one embodiment of a process for producing uncreped through-air dried tissue webs is shown.

It will be appreciated that variations from the apparatus and method illustrated in FIG. 7 can be made without departing from the general process. Shown is a twin wire former having a papermaking headbox 34, such as a layered headbox, which injects or deposits a stream 36 of an aqueous suspension of papermaking fibers onto the forming fabric 38 positioned on a forming roll 39. The forming fabric serves to support and carry the newly-formed wet web downstream in the process as the web is partially dewatered to a consistency of about 10 dry weight percent. Additional dewatering of the wet web can be carried out, such as by vacuum suction, while the wet web is supported by the forming fabric.

The wet web is then transferred from the forming fabric to a transfer fabric 40. In one embodiment, the transfer fabric can be traveling at a slower speed than the forming fabric in order to impart increased stretch into the web. This is commonly referred to as a “rush” transfer. Preferably the transfer fabric can have a void volume that is equal to or less than that of the forming fabric. The relative speed difference between the two fabrics can be from 0-60 percent, more specifically from about 15-45 percent. Transfer is preferably carried out with the assistance of a vacuum shoe 42 such that the forming fabric and the transfer fabric simultaneously converge and diverge at the leading edge of the vacuum slot.

The web is then transferred from the transfer fabric to the throughdrying fabric 44 with the aid of a vacuum transfer roll 46 or a vacuum transfer shoe, optionally again using a fixed gap transfer as previously described. The throughdrying fabric can be traveling at about the same speed or a different speed relative to the transfer fabric. If desired, the throughdrying fabric can be run at a slower speed to further enhance stretch. Transfer can be carried out with vacuum assistance.

In the past, highly textured throughdrying fabrics 44 with a three-dimensional conformation were used in order to create a pattern within the web as it dries. Not only are these fabrics relatively expensive, but high energy requirements were needed in order to create a pattern in the web. Through-air dried webs processed according to the present disclosure can be made using a relatively smooth and flat through drying fabric 44 in that the web is later fed through an embossing process.

The level of vacuum used for the web transfers can be from about 3 to about 15 inches of mercury (75 to about 380 millimeters of mercury), preferably about 5 inches (125 millimeters) of mercury. The vacuum shoe (negative pressure) can be supplemented or replaced by the use of positive pressure from the opposite side of the web to blow the web onto the next fabric in addition to or as a replacement for sucking it onto the next fabric with vacuum. Also, a vacuum roll or rolls can be used to replace the vacuum shoe(s).

While supported by the throughdrying fabric, the web is finally dried to a consistency of about 94 percent or greater by the throughdryer 48 and thereafter transferred to a carrier fabric 50. The dried base sheet 52 is transported to the reel 54 using carrier fabric 50 and an optional carrier fabric 56. An optional pressurized turning roll 58 can be used to facilitate transfer of the web from carrier fabric 50 to fabric 56. Suitable carrier fabrics for this purpose are Albany International 84M or 94M and Asten 959 or 937, all of which are relatively smooth fabrics having a fine pattern. Although not shown, reel calendering or subsequent off-line calendering can be used to improve the smoothness and softness of the base sheet.

In one embodiment, the reel 54 shown in FIG. 7 can run at a speed slower than the fabric 56 in a rush transfer process for building bulk into the paper web 52. For instance, the relative speed difference between the reel and the fabric can be from about 5% to about 25% and, particularly from about 12% to about 14%. Rush transfer at the reel can occur either alone or in conjunction with a rush transfer process upstream, such as between the forming fabric and the transfer fabric.

Referring to FIG. 5, one embodiment of a process for producing tissue products in accordance with the present disclosure is shown. Referring to FIG. 5, a first tissue ply 12 is conveyed past a series of idler rollers 122 towards a nip 124 that is located between an engraved roll 126 and an impression roll 128. The engraved roll 126 rotates in a counterclockwise direction while the impression roll 128 rotates in a clockwise direction. The first tissue ply 12 forms the top ply in the resulting multi-ply tissue product 10 as shown in FIG. 1.

The engraved roll 126 is generally a hard and non-deformable roll, such as a steel roll. The impression roll 128 may be a substantially smooth roll and can be a smooth roll having a covering, or made of, natural or synthetic rubber. The natural or synthetic rubber, for instance, can be polybutadiene or copolymers of ethylene and propylene or the like. In one aspect, the impression roll 128 has a hardness of greater than about 40 Shore A, such as from about 40 Shore A to about 100 Shore A including all increments of 1 Shore A therebetween. For example, in one aspect, the hardness of the impression roll 128 can be from about 40 Shore A to about 80 Shore A.

The impression roll 128 and the engraved roll 126 are urged together to form the nip 124 through which the first tissue ply 12 passes to impose an embossed design on the web. The engraved roll 126 comprises various embossing elements that include raised areas and cavities or depressions that together form the embossing pattern as shown in FIG. 1.

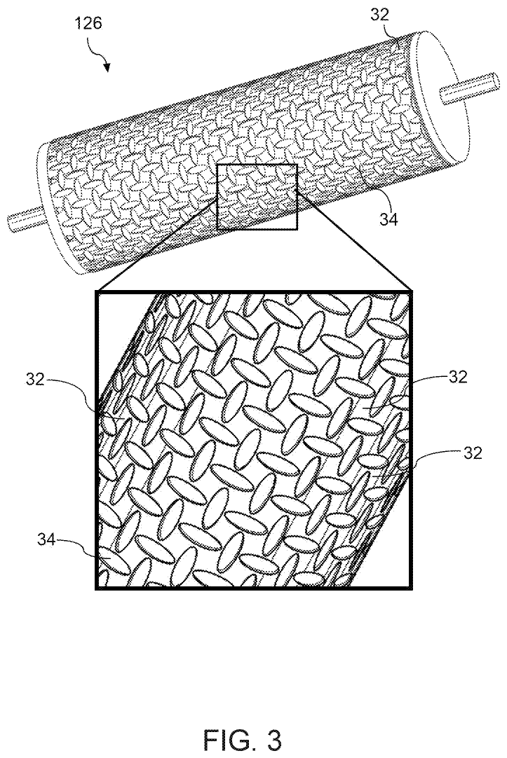

Referring to FIG. 3, one embodiment of an embossing roll 126 that may be used in accordance with the present disclosure is shown. The embossing roll 126 includes a negative engraved embossing pattern. The embossing pattern includes raised embossing elements 32 that form a surface of the roll. In this embodiment, the embossing elements 32 form a continuous pattern that completely surround recessed, discrete shapes 34. The recessed shapes 34, in this embodiment, are in the shape of ovals. The ovals extend vertically and horizontally, e.g. perpendicular to each other. The embossing elements 32 form the embossed portions 16 as shown in FIG. 6A. The recessed shapes, on the other hand, form the non-embossed discrete shapes 18 as shown in FIG. 6A. When the first tissue ply 12 is embossed against the embossing roll 126 as shown in FIG. 3, the embossing elements 32 form raised areas on the bottom surface of the tissue ply 12. The recessed shapes 34, on the other hand, can form elevated areas on the top surface of the tissue ply. In this embodiment, the embossing elements 32 form a continuous background pattern that not only produces the discrete shapes 18 but also does so in an aesthetically pleasing way.

In the embodiment illustrated in FIG. 3, the recessed shapes 34 are ovals. It should be understood, however, that any suitable shape can be created using the embossing process of the present disclosure. The shapes, for instance, can be circles, squares, triangles, or can be irregular and fanciful.

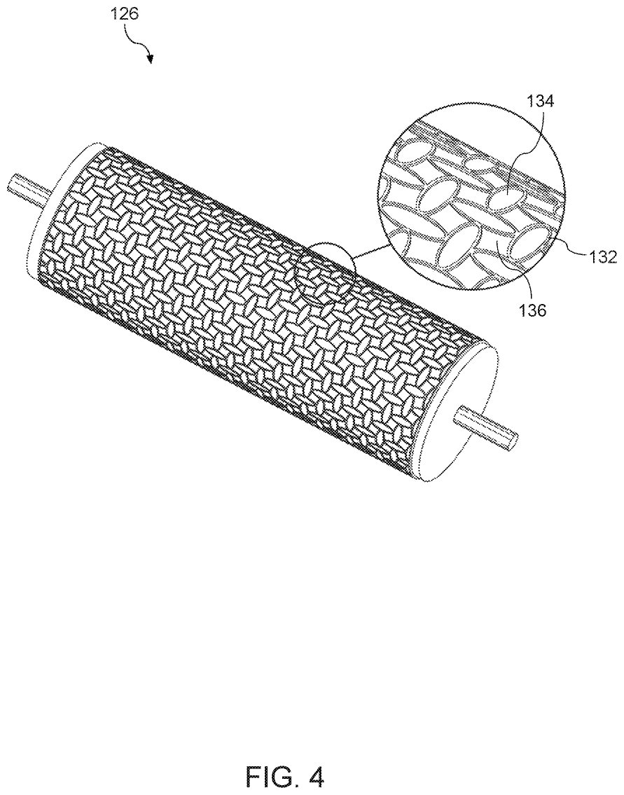

Referring to FIG. 4, another embodiment of an embossing roller 126 made in accordance with the present disclosure is shown. The embossing roller includes a pattern of embossing elements 32 that form raised areas and form an exterior surface of the roll. In this embodiment, the embossing elements 132 form a pattern of interconnected line elements. The line elements produce a pattern of two different discrete and recessed shapes. More particularly, the line embossing elements 132 form first discrete shapes 134 and second discrete shapes 136. The first discrete shapes 134 comprise ovals and are similar in appearance to the discrete shapes shown in FIG. 3. The recessed discrete shapes 136, however, have a square-like shape. Each recessed discrete shape 136 is surrounded by the embossing elements 132. In this manner, a tissue ply can be embossed that includes on a top surface having a pattern of non-embossed first shapes and second shapes. The embossed areas on the opposite side of the tissue ply, on the other hand, can comprise raised embossed line elements. As shown in FIG. 4, the embossed line elements can form a network and can be continuous and interconnected.

The embossing pattern present on the embossing roll 126 as shown in FIG. 5 can have an embossing height. The embossing height extends from a top surface of the embossing elements 32 to a bottom surface of the recessed discrete shapes 34. The overall height or depth of the embossing pattern can be generally greater than about 0.4 mm, such as greater than about 0.6 mm, such as greater than about 0.7 mm, such as greater than about 0.8 mm, and less than about 4 mm, such as less than about 2.5 mm, such as less than about 2 mm, such as less than about 1.5 mm, such as less than about 1.2 mm.

The above dimensions, however, are merely exemplary. These dimensions can be increased or decreased depending upon the tissue web being embossed and the product being formed. For instance, the embossing height or depth can be increased if applied to a tissue product with a greater basis weight.

In general, the depth of the recessed shapes 34 can comprise at least about 20%, such as at least about 40%, such as at least about 50%, such as at least about 55%, such as at least about 60% of the overall embossing depth. The depth of the recessed discrete shapes 34 is generally less than about 75%, such as less than about 70%, such as less than about 65%, such as less than about 60% of the total embossing depth.

With continued reference to FIG. 5, force or pressure is applied to one or both of the rolls 126 and 128 such that the rolls are urged against one another to form the nip 124. The pressure causes the impression roll 128 to deform about the embossing elements such that when the tissue ply 12 is pressed about the embossing elements, an embossing pattern is formed into the tissue ply 12 such that elevated shapes 18 form on one side of the tissue ply 12 and embossed portions 16 form on an opposite side of the tissue ply.

To form a two-ply tissue product, a second tissue ply 14 is conveyed around an idler roller 142 and then pressed into a nip 144 located between a substantially smooth roll 146 which may be made of rubber and a marrying roll 148, which may be a steel roll. The second tissue ply 14 is adapted to form the bottom ply in the resulting multi-ply tissue product 10. As it is conveyed, the second tissue ply 14 passes through a second nip 150 created between the engraved roll 126 and the marrying roll 148 where it is brought into contact with the first tissue ply 12, which now bears the embossing design as a result of being embossed by the engraved roll 126. The first and second plies 12 and 14 are joined together as they pass through the nip 150 to form a multi-ply tissue product 10.

As shown in FIG. 5, in certain embodiments, after the first tissue ply 12 passes through the nip 124 between the engraved roll 126 and the impression roll 128, an adhesive unit 152 can apply an adhesive or water to the distal ends of raised areas on the opposite surface of the tissue ply 12 that is in contact with the engraved roll 126. In one aspect, the adhesive unit 152 is positioned and configured only to apply adhesive or water to the embossed portions 16 on the first tissue ply 12.

The embossed first tissue ply 12 with the applied adhesive or water then advances further to the nip 150 between the engraved roll 126 and the marrying roll 148. At this point, the non-embossed second ply 14 is attached to the embossed first ply 12 and both plies are then conveyed around the marrying roll 148 to form the two-ply tissue product 10 which can be subsequently spirally wound into a roll (not shown).

Through the above process, a tissue product 10 can be formed as shown in FIG. 1. The tissue product 10 can comprise a two-ply tissue product in which the first ply 12 is the embossed ply that forms the top of the product. The second ply 12, on the other hand, can be a non-embossed ply that remains relatively planar and forms the bottom surface of the product.

In certain embodiments, to improve processability and one or more physical properties, one or more of the fibrous plies may be subjected to preconditioning to impart moisture and/or heat to the tissue plies prior to entering an embossing nip. For example, preconditioning mechanisms may be positioned upstream of the nip located between the engraved roll and the impression role to introduce moisture and/or heat to the first tissue ply prior to embossing. Methods and arrangements for applying moisture and heat (e.g., steam) to tissue webs are known to skilled artisans and can be employed and fall within the scope of the present invention. By way of example, steam can be applied to either or both sides of a web prior to embossing.

In one aspect, either the engraved roll 126 and/or the impression roll 128 are heated for producing a heated nip 124. Alternatively, embossing can be accomplished without a heated nip.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A tissue product comprising:
a first tissue ply including a first surface and a second and opposite surface, the second surface having a surface area;
a second tissue ply including a first surface and a second and opposite surface;
an embossing pattern formed into the first tissue ply, the embossing pattern including embossed portions that surround and form a pattern of discrete shapes on the first surface of the tissue ply, the discrete shapes having a top surface lying in a first surface plane, the embossed portions forming raised areas on the second surface of the first tissue ply, an upper surface of the raised areas lying in a second surface plane that is spaced from the first surface plane; and
wherein the second surface of the first tissue ply is adhered to the first surface of the second tissue ply, and wherein the embossed portions occupy greater than about 10% of the surface area of the second surface of the first tissue ply.

2. A tissue product as defined in claim 1, wherein the raised areas occupy greater than about 15% of the surface area of the second surface of the first tissue ply, and less than about 40%.

3. A tissue product as defined in claim 1, wherein the embossed portions form a continuous background pattern that form a perimeter around each discrete shape in the pattern.

4. A tissue product as defined in claim 3, wherein the discrete shapes are raised above the continuous background pattern on the first surface of the first tissue ply.

5. A tissue product as defined in claim 1, wherein the discrete shapes comprise non-embossed areas on the first surface of the first tissue ply.

6. A tissue product as defined in claim 1, wherein the first tissue ply comprises a through air-dried web.

7. A tissue product as defined in claim 1, wherein the first tissue ply and the second tissue ply comprise uncreped through-air dried webs.

8. A tissue product as defined in claim 1, wherein the embossed portions form a pattern of first shapes and second shapes.

9. A tissue product as defined in claim 1, wherein each tissue ply has a basis weight of from about 10 gsm to about 35 gsm.

10. A tissue product as defined in claim 1, wherein the tissue product has a basis weight of from about 28 gsm to about 80 gsm.

11. A tissue product as defined in claim 1, wherein the first surface plane and the second surface plane are parallel and wherein a distance from the first surface plane to the second surface plane is greater than about 0.4 mm, and less than about 2.5 mm.

12. A tissue product as defined in claim 1, wherein the second tissue ply is a non-embossed sheet.

13. A tissue product as defined in claim 1, wherein the embossed portions are continuous and intersecting.

14. A tissue product as defined in claim 1, wherein the first tissue ply and the second tissue ply each comprise at least 50% by weight pulp fibers, each ply having a bulk of greater than about 5 cc/g.

15. A tissue product as defined in claim 1, wherein the first tissue ply and second tissue ply are spirally wound into a roll.

16. A tissue product as defined in claim 1, wherein the tissue product comprises a bath tissue.

17. A tissue product as defined in claim 1, wherein the tissue product comprises a stack of interfolded individual sheets.

18. A tissue product as defined in claim 1, wherein the first tissue ply and second tissue ply comprise wet laid webs.

19. A tissue product as defined in claim 1, wherein the first tissue ply and second tissue ply comprise foam formed webs.

20. A tissue product made by a process comprising:
passing a first tissue ply having a first surface and a second and opposite surface through a first nip between an engraved roll and an impression roll in order to emboss an embossing pattern into the first tissue ply, the engraved roll comprising a pattern of embossing elements that form an exterior surface of the engraved roll and surround recess shaped elements, the embossing pattern including embossed portions corresponding to the embossing elements surrounding a pattern of discrete shapes on the first surface of the tissue ply, the discrete shapes having a top surface lying in a first surface plane, the embossed portions forming raised areas on the second surface of the first tissue ply, an upper surface of the raised areas lying in a second surface plane that is spaced from the first surface plane;
applying an adhesive or water to the raised areas on the embossed first tissue ply; and
passing the first tissue ply and a second tissue ply through a second nip formed by a marrying roll to adhere the second tissue ply to the first tissue ply where the raised areas are located.

21. A tissue product as defined in claim 20, wherein the embossed portions form a continuous background pattern that form a perimeter around each discrete shape in the pattern.

22. A tissue product as defined in claim 20, wherein water is applied to the first tissue ply prior to embossing.
